(19) United States
(12) Patent Application Publication
(10) Pub. No.: US 2026/0261904 A1
(43) Pub. Date: Sep. 3, 2026

(54) USER EQUIPMENT, METHOD PERFORMED BY USER EQUIPMENT, BASE STATION, AND METHOD PERFORMED BY BASE STATION

(71) Applicant: NEC Corporation, Minato-ku, Tokyo (JP)

(72) Inventors: Yuhua CHEN, Tokyo (JP); Pravjyot DEOGUN, Tokyo (JP); Caroline LIANG, Tokyo (JP); Robert ARNOTT, Tokyo (JP)

(73) Assignee: NEC Corporation, Minato-ku, Tokyo (JP)

(21) Appl. No.: 18/872,916

(22) PCT Filed: Jun. 21, 2023
(86) PCT No.: PCT/JP2023/023032

§ 371 Date: Dec. 9, 2024

(30) Foreign Application Priority Data
Jun. 29, 2022 (GB) 2209591.3

(51) Int. Cl. H04W 28/02; H04W 72/23

(52) U.S. Cl. CPC H04W 28/0278; H04W 72/23

(57) ABSTRACT

The present disclosure relates to a user equipment (UE) (3A, 3B) including: means for determining whether to transmit a buffer status report (BSR) to a base station (5) based on at least one of: a volume of data stored at the UE (3A, 3B); a volume of data transmitted by the UE (3A, 3B); a threshold value; or a BSR indication that indicates whether the BSR is to be transmitted from the UE (3A, 3B) to the base station (5); and means for transmitting a BSR to the base station (5), based on the determining.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to buffer status reports (BSR) in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IOT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and 3GPP TS 37.340 V16.7.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or RAN node is used herein to refer to any such node. The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

The term extended reality (XR) refers to all real-and-virtual combined environments and associated human-machine interactions generated by computer technology and wearables. It includes representative forms such as augmented reality (AR), mixed reality (MR), and virtual reality (VR) and the areas interpolated among them. 3GPP Technical Report (TR) 26.928 V16.1.0 discusses extended Reality (XR) in the context of 5G radio and network services. This document introduces baseline technologies for XR type of services and applications, outlining the quality of experience (QoE)/quality of service (QOS) issues of XR-based services, the delivery of XR in 5G systems, and an architectural model of 5G media streaming defined in 3GPP TS 26.501 V16.9.0. In addition to the conventional service category, interactive, streaming, download, and split compute/rendering are identified as new delivery categories for XR. 3GPP TR 38.838 V17.0.0 is a study on XR service and in particular the traffic models and characteristics aspects of XR in Release 17.

Buffer status reports (BSR) are transmitted from a UE to a base station to indicate an amount of data for uplink transmission stored in a buffer of the UE. This information can be used by the base station to schedule uplink resources to be used by the UE to transmit the stored data. As described in detail later, a BSR may include a number of bits for indicating a logical channel (LCH) or logical channel group (LCG), and a number of bits for indicating a corresponding buffer size at the UE.

In XR implementations, which present challenging service requirements, there is a need for more efficient resource scheduling and allocation. The inventors have realised that there is a need for more reliable and accurate buffer status reporting. However, there is a problem that transmission of a BSR may not always be reliably triggered. For example, for a Regular BSR, there is a problem that transmission of the BSR may not be triggered when additional data arrives in the buffer for the same LCH or LCG. Similarly, for a Padding BSR (that is included in an uplink data message when there are sufficient padding bits in the message), there is a problem that the BSR has a lower priority than the data transmission and is not included in the transmission unless there are sufficient padding bits, and so may not be reliably transmitted to the base station. For periodical BSR there is a problem that the frequency of transmission of the BSR may be insufficient (for example, for Burst Data Arrival), and configuring periodical BSR having very short periodicities may be impractical.

Moreover, there is a problem that the precision of the buffer size indicated in the BSR can be insufficient, and it also is desirable for UE buffer estimations to be closer to the actual UE buffer values since this can result in improved XR capacity and decreased resource utilisation.

More generally, there is a need for improved mechanisms that provide more efficient resource and scheduling for XR service characteristics, including semi-persistent scheduling (SPS), configured grant (CG) and dynamic grant (DG).

### CITATION LIST

### Non Patent Literature

NPL 1: 3GPP Technical Specification (TS) 38.300 V16.7.0
NPL 2: 3GPP TS 37.340 V16.7.0
NPL 3: 3GPP Technical Report (TR) 26.928 V16.1.0
NPL 4: 3GPP TS 26.501 V16.9.0
NPL 5: 3GPP TR 38.838 V17.0.0

### SUMMARY OF INVENTION

### Technical Problem

Accordingly, the present disclosure seeks to provide methods and associated apparatus that address or at least alleviate (at least some of) the above-described issues.

### Solution to Problem

In one aspect, the disclosure provides a user equipment (UE) comprising: means for determining whether to transmit a buffer status report (BSR) to a base station based on at least one of: whether a volume of data stored at the UE is equal to or less than a first threshold; whether a volume of data transmitted by the UE since transmission of a previous BSR is equal to or greater than a second threshold; whether an uplink grant size is equal to or greater than a third threshold; whether a difference between a current buffer size of a buffer at the UE 10 and highest or lowest buffer size is equal to or greater than a fourth threshold; or a BSR indication that indicates whether the BSR is to be transmitted; and means for transmitting a BSR to the base station, based on the determining.

The means for determining may be configured to determine to transmit the BSR to the base station in a case where the volume of data transmitted by the UE since transmission of a previous BSR is greater than a threshold and there is data in a buffer at the UE.

The UE may further comprise means for storing a value of the volume of data transmitted by the UE; and means for setting the value of the volume of data transmitted by the UE to zero in a case where the UE transmits the BSR.

The second threshold may correspond to a buffer size reported in a previous BSR, and the means for determining may be configured to determine to transmit a BSR to the base station in a case where a sum of data transmitted by the UE to the base station since a transmission of the previous BSR and data scheduled for transmission from the UE to the base station is equal to or greater than the second threshold and there is data in a buffer at the UE.

The means for determining may be configured to determine to transmit the BSR to the base station in a case where the highest buffer size reported in a previous BSR, minus a current buffer size of a buffer at the UE, minus the volume of data transmitted by the UE since the transmission of the previous BSR, is equal to or greater than the fourth threshold.

The means for determining may be configured to determine to transmit the BSR to the base station in a case where a current buffer size at the UE minus the lowest buffer size reported in a previous BSR, minus the volume of data transmitted by the UE since the transmission of the previous BSR, is equal to or greater than the fourth threshold.

The UE may further comprise: means for receiving, from a base station, the BSR indication, wherein the means for transmitting the BSR is configured to transmit the BSR to the base station in a case where the BSR indication indicates that the BSR is to be transmitted to the base station.

The BSR indication may be included in a physical downlink control channel (PDCCH).

The BSR indication may be provided as a 1-bit field in the PDCCH.

The BSR indication may comprise a media access control (MAC) Control Element (CE).

The BSR indication may be defined per logical channel group.

The BSR may be a Regular BSR.

In a case where the BSR indication indicates that the BSR is to be transmitted to the base station, the means for transmitting may be configured to transmit a BSR for one or more logical channel groups indicated in the BSR indication.

In one aspect, the disclosure provides a user equipment (UE) comprising: means for transmitting, to a base station, an indication of a difference between a buffer size corresponding to a buffer status report (BSR) and a volume of data stored in a buffer at the UE.

The buffer size corresponding to BSR may be an upper limit of a range of buffer sizes indicated in the BSR.

The indication may include a value equal to the upper limit of the range of buffer sizes indicated in the BSR minus the volume of data stored in a buffer at the UE.

The buffer size corresponding to a BSR may be a lower limit of a range of buffer sizes indicated in the BSR.

The indication may include a value equal to the volume of data stored in a buffer at the UE minus the lower limit of the range of buffer sizes indicated in the BSR.

The UE may be configured to transmit the indication to the base station in a case where at least one of: the transmission of the indication is enabled by the network; a Regular BSR, Periodical BSR or Truncated BSR reported has been triggered for transmission to the base station; a value equal to the upper limit of the range of buffer sizes indicated in the BSR minus the volume of data stored in a buffer at the UE is equal to or greater than a threshold; a value equal to the volume of data stored in a buffer at the UE minus the lower limit of the range of buffer sizes indicated in the BSR is equal to or greater than a threshold; or a grant size for the UE for a Regular BSR, Periodical BSR or Truncated BSR is equal to or greater than a threshold.

In one aspect, the disclosure provides a user equipment (UE) comprising: means for storing a plurality of tables, each table mapping each of a plurality of indices to respective range of a buffer size of the UE; means for receiving an indication of a table of the plurality of tables to use to determine an index that corresponds to a size of a buffer at the UE; and means for transmitting the index to a base station.

In one aspect, the disclosure provides a user equipment (UE) comprising: means for transmitting a buffer status report (BSR) media access control (MAC) control element (CE) to a base station; wherein the BSR MAC CE comprises greater than 8 bits for indicating a buffer size.

In one aspect, the disclosure provides a user equipment (UE) comprising:

means for receiving information for requesting or enabling transmission of information for traffic assistance including at least one of: a periodicity or packet generation rate, a time offset, a jitter range, or a requested configuration related to uplink data transmissions from a UE to the base station; means for transmitting the information for traffic assistance based on the information; and means for receiving information for configuring or scheduling an uplink resource for uplink transmission, based on the information for traffic assistance.

In one aspect, the disclosure provides a method performed by a user equipment (UE), the method comprising: determining whether to transmit a buffer status report (BSR) to a base station based on at least one of: whether a volume of data stored at the UE is equal to or less than a first threshold; whether a volume of data transmitted by the UE since transmission of a previous BSR is equal to or greater than a second threshold; whether an uplink grant size is equal to or greater than a third threshold; whether a difference between a current buffer size of a buffer at the UE and highest or lowest buffer size is equal to or greater than a fourth threshold; or a BSR indication that indicates whether the BSR is to be transmitted; and transmitting a BSR to the base station, based on the determining.

In one aspect, the disclosure provides a method performed by a user equipment (UE), the method comprising: transmitting, to a base station, an indication of a difference between a buffer size corresponding to a buffer status report (BSR) and a volume of data stored in a buffer at the UE.

In one aspect, the disclosure provides a method performed by a user equipment (UE), the method comprising: storing a plurality of tables, each table mapping each of a plurality of indices to respective range of a buffer size of the UE; receiving an indication of a table of the plurality of tables to use to determine an index that corresponds to a size of a buffer at the UE; and transmitting the index to a base station.

In one aspect, the disclosure provides a method performed by a user equipment (UE), the method comprising: transmitting a buffer status report (BSR) media access control (MAC) control element (CE) to a base station; wherein the BSR MAC CE comprises greater than 8 bits for indicating a buffer size of a buffer at the UE for uplink transmission.

In one aspect, the disclosure provides a method performed by a user equipment (UE), the method comprising: receiving information for use by a base station in requesting or enabling transmission of uplink data transmission information including at least one of: a periodicity or packet generation rate, a time offset, a jitter range, or a requested configuration related to uplink data transmissions from a UE to the base station; transmitting the uplink data transmission information based on the information; and receiving information for configuring or scheduling a uplink resource for uplink transmission, based on the uplink data transmission information.

In one aspect, the disclosure provides a base station comprising: means for transmitting, to a user equipment (UE), at least one of: a threshold for determining whether the UE is to transmit a buffer status report (BSR); or a BSR indication that indicates whether the UE is to transmit the BSR.

In one aspect, the disclosure provides a base station comprising: means for receiving, from a user equipment (UE), an indication of a difference between a buffer size corresponding to a buffer status report (BSR) and a volume of data stored in a buffer at the UE; and means for determining, using the indication, a current buffer size at the UE.

In one aspect, the disclosure provides a base station comprising: means for transmitting, to a user equipment (UE) that stores a plurality of tables, each table mapping each of a plurality of indices to respective range of a buffer size of the UE, an indication of a table of the plurality of tables to use to determine an index that corresponds to a size of a buffer at the UE; and means for receiving the index from the UE.

In one aspect, the disclosure provides a base station comprising: means for transmitting information for requesting or enabling transmission of information for traffic assistance including at least one of: a periodicity or packet generation rate, a time offset, a jitter range, or a requested configuration related to uplink data transmissions from a UE to the base station; means for receiving the information for traffic assistance based on the information; and means for configuring or scheduling an uplink resource for uplink transmission, based on the information for traffic assistance.

In one aspect, the disclosure provides a method performed by a base station, the method comprising: transmitting, to a user equipment (UE), at least one of: a threshold for determining whether the UE is to transmit a buffer status report (BSR); or a BSR indication that indicates whether the UE is to transmit the BSR.

In one aspect, the disclosure provides a method performed by a base station, the method comprising: receiving, from a user equipment (UE), an indication of a difference between a buffer size corresponding to a buffer status report (BSR) and a volume of data stored in a buffer at the UE; and determining, using the indication, a current buffer size at the UE.

In one aspect, the disclosure provides a method performed by a base station, the method comprising: transmitting, to a user equipment (UE) that stores a plurality of tables, each table mapping each of a plurality of indices to respective range of a buffer size of the UE, an indication of a table of the plurality of tables to use to determine an index that corresponds to a size of a buffer at the UE; and receiving the index from the UE.

In one aspect, the disclosure provides a method performed by a base station, the method comprising: receiving, from a user equipment, a buffer status report (BSR) media access control (MAC) control element (CE) comprising greater than 8 bits for indicating a buffer size; and determining a buffer size at the UE using the BSR MAC CE.

In one aspect, the disclosure provides a method performed by a base station, the method comprising: transmitting information for requesting or enabling transmission of information for traffic assistance including at least one of: a periodicity or packet generation rate, a time offset, a jitter range, or a requested configuration related to uplink data transmissions from a UE to the base station; receiving the information for traffic assistance based on the information; and configuring or scheduling an uplink resource for uplink transmission, based on the information for traffic assistance.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the disclosure will be described in detail in the context of a 3GPP system (5G networks), the principles of the disclosure can be applied to other systems as well.

The present disclosure is defined by the claims appended hereto. Aspects of the disclosure are as set out in the independent claims. Some optional features are set out in the dependent claims.

However, each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the present disclosure will now be described, by way of example, with reference to the accompanying drawings.

FIG. 1 illustrates schematically a mobile (cellular or wireless) telecommunication system to which embodiments of the disclosure may be applied.

FIG. 2 is a schematic block diagram of a mobile device forming part of the system shown in FIG. 1.

FIG. 3 is a schematic block diagram of an access network node (e.g. base station) forming part of the system shown in FIG. 1.

FIG. 4 is a schematic block diagram of a core network node forming part of the system shown in FIG. 1.

FIG. 5 shows a short buffer status report.

FIG. 6 shows a lookup table for a buffer status report.

FIG. 7 shows a long buffer status report.

FIG. 8 shows an extended short buffer status report.

FIG. 9 shows an extended long buffer status report.

FIG. 10 is schematic diagrams illustrating some exemplary embodiments of the present disclosure.

FIG. 11 is schematic diagrams illustrating some exemplary embodiments of the present disclosure.

FIG. 12 is schematic diagrams illustrating some exemplary embodiments of the present disclosure.

FIG. 13 is schematic diagrams illustrating some exemplary embodiments of the present disclosure.

FIG. 14 is schematic diagrams illustrating some exemplary embodiments of the present disclosure.

FIG. 15 is schematic diagrams illustrating some exemplary embodiments of the present disclosure.

FIG. 16 is schematic diagrams illustrating some exemplary embodiments of the present disclosure.

FIG. 17 is schematic diagrams illustrating some exemplary embodiments of the present disclosure.

FIG. 18 is schematic diagrams illustrating some exemplary embodiments of the present disclosure.

FIG. 19 is schematic diagrams illustrating some exemplary embodiments of the present disclosure.

FIG. 20 is schematic diagrams illustrating some exemplary embodiments of the present disclosure.

FIG. 21 is schematic diagrams illustrating some exemplary embodiments of the present disclosure.

FIG. 22 is schematic diagrams illustrating some exemplary embodiments of the present disclosure.

### DESCRIPTION OF EMBODIMENTS

### Overview

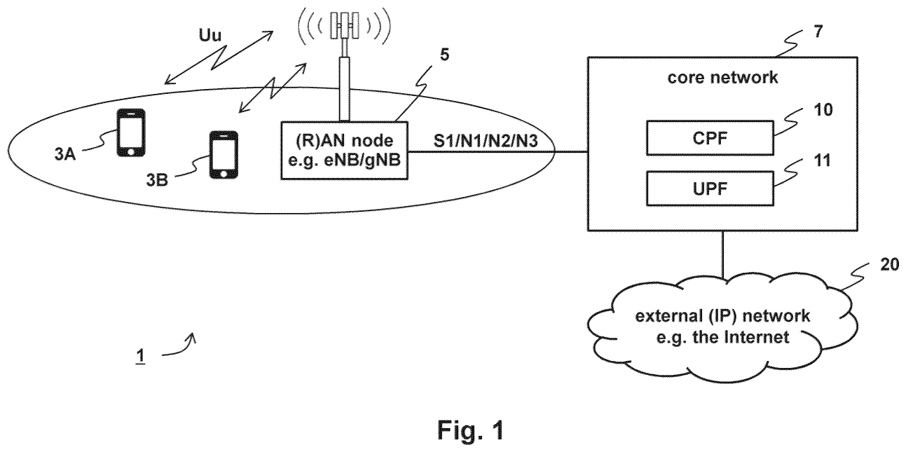

FIG. 1 illustrates schematically a mobile (cellular or wireless) telecommunication system 1 to which embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations/(R)AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification and release. The core network 7 may typically also include an Authentication Server Function (AUSF), a Unified Data Management (UDM) entity, a Policy Control Function (PCF), an Application Function (AF), amongst others. It will be appreciated that the nodes or functions may have different names in different systems. The core network 7 is coupled (via the UPF 11) to a data network 20, such as the Internet or a similar Internet Protocol (IP) based network. The core network 7 may also be coupled to an Operations and Maintenance (OAM) function (not shown).

It will be appreciated that each mobile device 3 may support one or more services which may fall into one of the categories defined above (URLLC/eMBB/mMTC). Each service will typically have associated requirements (e.g. latency/data rate/packet loss requirements, etc.), which may be different for different services. Each mobile device 3 may be configured with appropriate power saving operation such as Discontinuous Reception (DRX), Discontinuous

Transmission (DTX), and/or the like. The power saving operation may depend on the category of one or more services used, UE capabilities, and other factors (such as QoE/QoS, throughput, at least one serving cell, network load, and/or the like). The DRX configuration used by a UE 3 may be adapted dynamically to suite a wide range of services, such as XR data.

### User Equipment (UE)

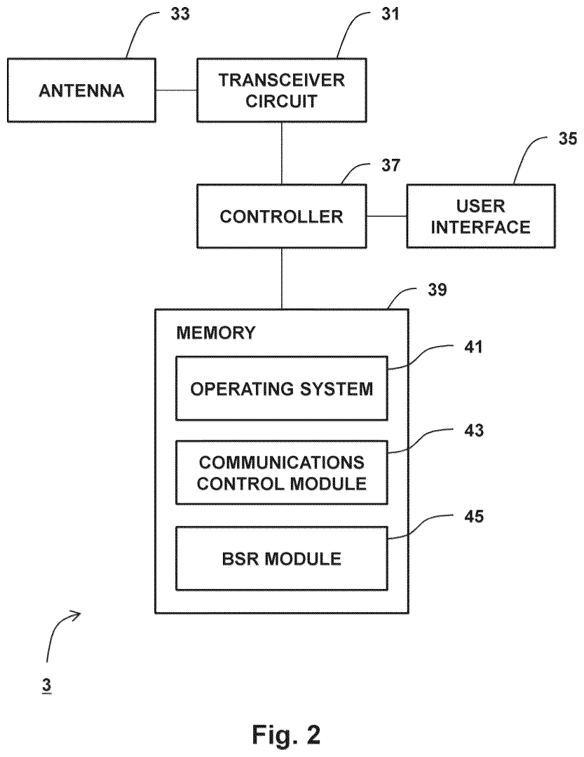

FIG. 2 is a block diagram illustrating the main components of the mobile device (UE) 3 shown in FIG. 1. As shown, the UE 3 includes a transceiver circuit 31 which is operable to transmit signals to and to receive signals from one or more connected nodes via one or more antennas 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a buffer status report (BSR) module 45.

The communications control module 43 is responsible for handling (generating/sending/receiving) signalling messages and uplink/downlink data packets between the UE 3 and other nodes, including (R)AN nodes 5 and core network nodes. The signalling may comprise control signalling (e.g. via RRC/MAC/PHY/DCI) related to the transmission of BSR. It will be appreciated that the communications control module 43 may include a number of sub-modules (‘layers’ or ‘entities’) to support specific functionalities. For example, the communications control module 43 may include a PHY sub-module, a Media

Access Control (MAC) sub-module, an RLC sub-module, a PDCP sub-module, an SDAP sub-module, an IP sub-module, a radio resource control (RRC) sub-module, etc.

The BSR module 45 is responsible for generating a BSR, and for determining to transmit the BSR to the base station 5. The BSR module 45 may also be responsible for generating and transmitting any other suitable information related to a BSR. Methods of transmitting a BSR are described below. Exemplary types and configurations of BSR that can be transmitted from a UE 3 to a base station 5 are also described below.

### Access Network Node (Base Station)

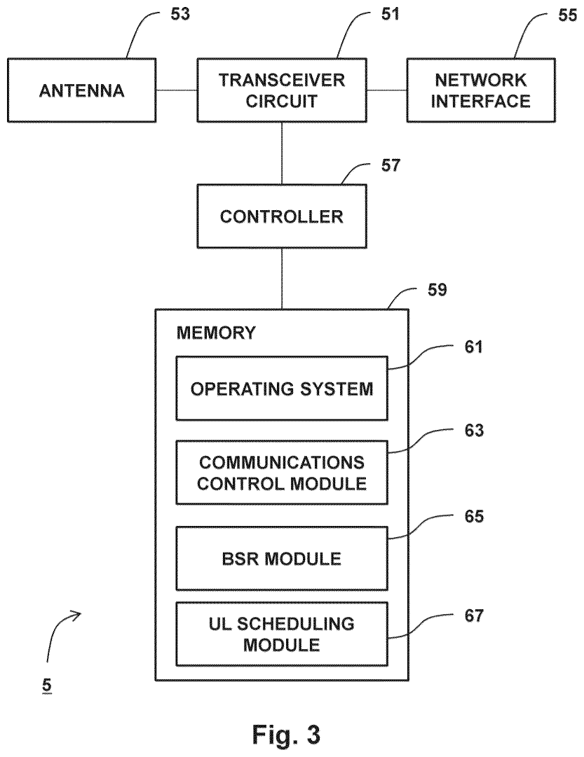

FIG. 3 is a block diagram illustrating the main components of the base station 5 (or a similar access network node) shown in FIG. 1. As shown, the base station 5 includes a transceiver circuit 51 which is operable to transmit signals to and to receive signals from one or more connected UEs 3 via one or more antennas 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, a BSR module 65 and an UL scheduling module 67.

The communications control module 63 is responsible for handling (generating/sending/receiving) signalling between the base station 5 and other nodes, such as the UE 3 and the core network nodes. The signalling may comprise control signalling (e.g. via RRC/MAC/PHY/DCI) related to buffer status reports. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The BSR module 65 is responsible for the transmission/reception of any BSR-related information transmitted/received to or from the UE 3. For example, the BSR module 65 may generate an indication that a UE 3 is to transmit a BSR.

The uplink (UL) scheduling module 67 is responsible for generating an UL grant for the transmission of data from a UE 3 to the base station 5. The base station may schedule or allocate resources for an UL transmission for a UE 3 based on a BSR received from the UE 3.

### Core Network Function

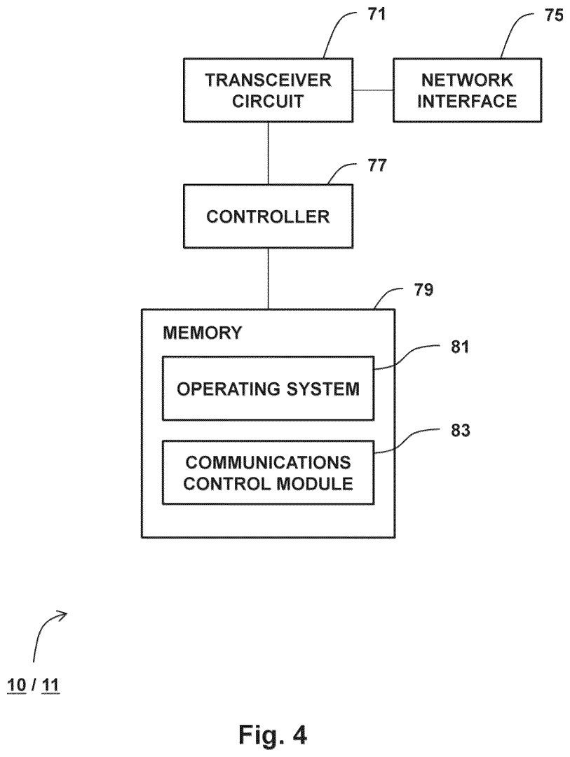

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signaling between the core network function and other nodes, such as the UE 3, the base station 5, and other core network nodes.

### Buffer Status Reports

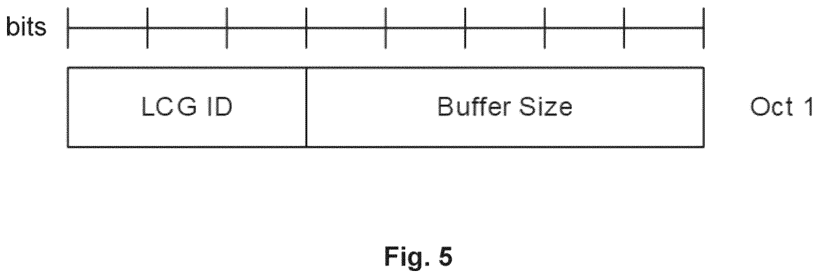

FIG. 5 shows an example of a Short BSR MAC control element (MAC CE). As shown in the FIG. 5, the short BSR comprise 3 bits for indicating an LCG ID, and also includes 5 bits for indicating the buffer size (a total of 8 bits).

The Buffer Size field identifies the total amount of data available (according to a data volume calculation procedure) across all logical channels of a logical channel group after the MAC PDU has been built (i.e. after the logical channel prioritization procedure, which may result the value of the Buffer Size (BS) field to zero). The amount of data is indicated in number of bytes. The size of the RLC headers and MAC subheaders are not considered in the buffer size computation.

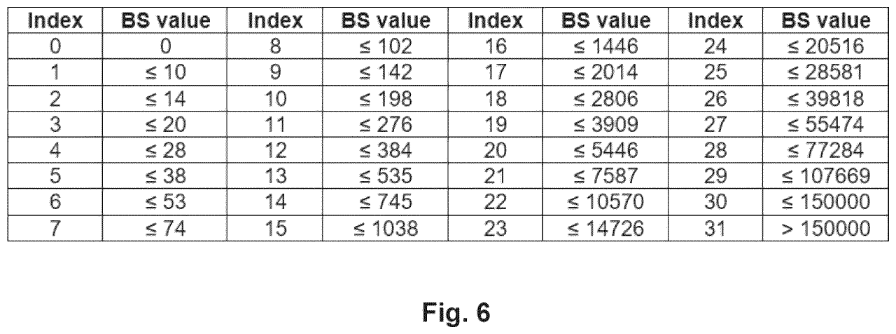

The 5 bits for indicating the buffer size can be used to indicate an index between 0 and 31. FIG. 6 shows an exemplary table that can be used to map the indicated index to the size of the buffer. The table may be stored and used, for example, at the base station 5. The amount of data is indicated in number of bytes. For example, when the 5 bits used to indicate the buffer size correspond to an index of 22, this indicates that the buffer size is greater than 7587 bytes, and smaller than or equal to 10570 bytes. It will be appreciated, therefore, that the base station 5 can use the table of FIG. 6 to determine the buffer size at the UE 3 based on the BSR.

As shown in FIG. 6, the range for the buffer size value becomes less precise for larger BSR indices (larger buffer size values). For example, when the indicated index is 3, the buffer size value is greater than 14 and less than or equal to 20, corresponding to a range of 6 bytes. In contrast, when the indicated index is 28, the buffer size value is greater than or equal to 55474 and 77284, corresponding to a range of 21810 bytes.

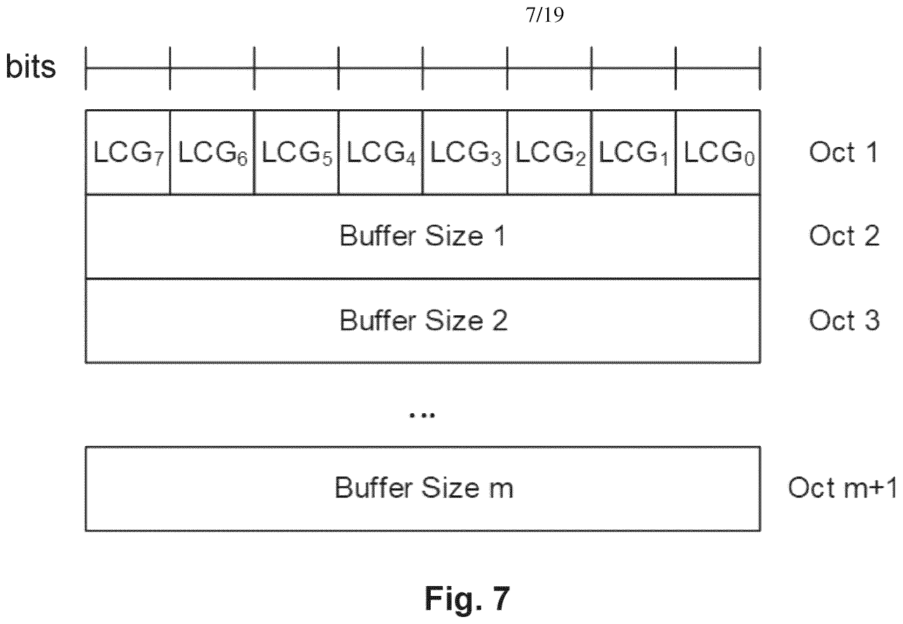

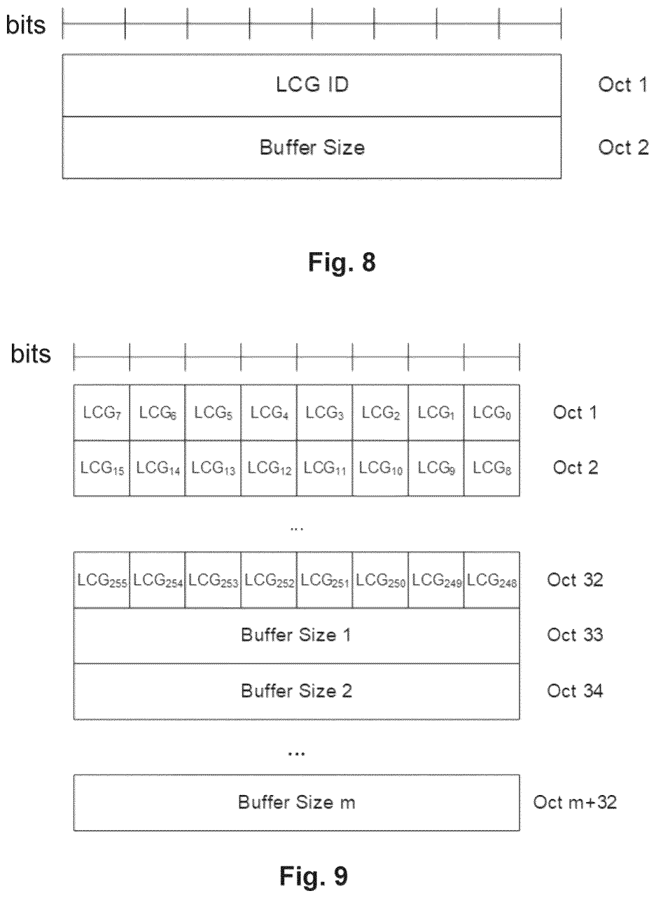

FIGS. 7 to 9 show further examples of BSR that may be transmitted from the UE 3 to the base station 5. FIG. 7 shows an example of a Long BSR MAC CE, which indicates a plurality of buffer sizes corresponding to a plurality of LCG. The LCGi field indicates the presence of the Buffer Size field for the logical channel group i. The LCGi field set to 1 indicates that the Buffer Size field for the logical channel group i is reported. The LCGi field set to 0 indicates that the Buffer Size field for the logical channel group i is not reported. For the Long Truncated BSR format and the Extended Long Truncated BSR format, this field indicates whether logical channel group i has data available. The LCGi field set to 1 indicates that logical channel group i has data available. The LCGi field set to 0 indicates that logical channel group i does not have data available.

As can be seen in the FIG. 7, in the Long BSR, eight bits are used to indicate each of the buffer sizes (corresponding to an index of between 0 and 255). For the Long BSR format, the Long Truncated BSR format, the Extended Long BSR format, and the Extended Long Truncated format, the Buffer Size fields are included in ascending order based on the LCGi. For the Long Truncated BSR format and the Extended Long Truncated format the number of Buffer Size fields included is maximised, while not exceeding the number of padding bits. An exemplary lookup table for the 8 bit indication of buffer size, similar to that shown in FIG. 6 for 5 bits, is shown in Table 1 below.

TABLE 1
Buffer Size Table for 8 bit indication:

| Index | BS value |
|---|---|
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 116 | ≤13838 |
| 116 | ≤14736 |
| 117 | ≤15692 |
| 118 | ≤16711 |
| 118 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

### BSR MAC CEs May Comprise:

Short BSR format (fixed size); or
Extended Short BSR format (fixed size); or
Long BSR format (variable size); or
Extended Long BSR format (variable size); or
Short Truncated BSR format (fixed size); or
Extended Short Truncated BSR format (fixed size); or
Long Truncated BSR format (variable size); or
Extended Long Truncated BSR format (variable size).

A BSR can be triggered for transmission from the UE 3 to the base station 5. For example, a BSR can be triggered if UL data, for a logical channel which belongs to an LCG, becomes available to the MAC entity; and either:
this UL data belongs to a logical channel with higher priority than the priority of any logical channel containing available UL data which belong to any LCG; or
none of the logical channels which belong to an LCG contains any available

UL data, in which case the BSR can be referred to as ‘Regular BSR’.

A BSR can also be triggered if a number of padding bits in an uplink data message is equal to or larger than the size of the Buffer Status Report MAC CE plus its subheader, in which case the BSR can be referred to as ‘Padding BSR’.

A BSR can also be triggered based on a timer (e.g. a retxBSR-Timer), when at least one of the logical channels which belong to an LCG contains UL data, in which case the BSR can be referred to as ‘Regular BSR’.

A BSR can also be scheduled for periodic transmission based on a timer (e.g. a periodicBSR-Timer), in which case the BSR can be referred to as ‘Periodic BSR’.

A MAC PDU may contain at most one BSR MAC CE, even when multiple events have triggered a BSR. A regular BSR and a Periodic BSR may have precedence over a Padding BSR. The MAC entity may restart retxBSR-Timer upon reception of a grant for transmission of new data on any UL-SCH.

It will be appreciated that the methods of transmitting (and determining to transmit) buffer status reports described below can be applied to any suitable type of BSR.

The BSR is received at the base station 5, and may be used by the base station to configure and/or schedule uplink resources for transmission of uplink data from the UE 3 to the base station 5. For example, in configured grant Type 1, an uplink grant is provided by RRC, and stored as a configured uplink grant. In configured grant Type 2, an uplink grant is provided by physical downlink control channel (PDCCH), and stored or cleared as configured uplink grant based on L1 signalling indicating configured uplink grant activation or deactivation. Type 1 and Type 2 are configured by RRC for a Serving Cell per bandwidth part (BWP). Multiple configurations can be active simultaneously in the same BWP. For Type 2, activation and deactivation are independent among the Serving Cells. For the same BWP, the MAC entity can be configured with both Type 1 and Type 2. The base station 5 may also (or alternatively) perform semi-persistent scheduling (SPS) or dynamic grant (DG).

Further examples of BSR are provided in Technical Specification (TS) 38.321 V17.0.0.

### BSR Transmission

Exemplary methods of the present disclosure for transmitting BSR from a UE 3 to a base station 5 will now be described.

### BSR Polling

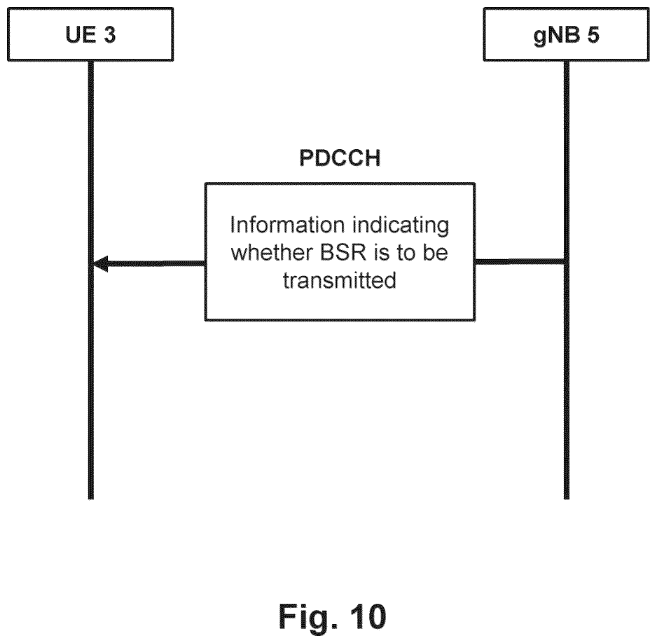

FIG. 10 shows an example of BSR polling via physical downlink control channel (PDCCH) signalling.

As shown in the FIG. 10, the base station 5 transmits, to the UE 5, an indication of whether BSR is to be transmitted. For example, a BSR polling field may be included in the PDCCH to indicate whether a regular BSR should be triggered/included. The BSR polling field may be a 1-bit field. However, any other suitable number of bits could be used for the BSR polling field.

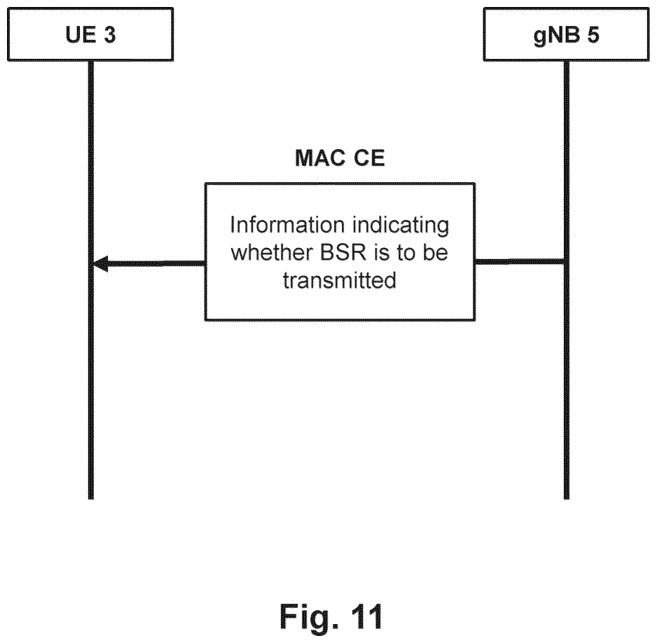

FIG. 11 shows an alternative in which a MAC CE includes the indication of whether BSR is to be transmitted. The indication may indicate whether BSR is to be transmitted per logical channel group.

When the UE 3 receives the indication, the UE triggers/transmits regular BSR to the base station 5 for all, or indicated, logical channel groups.

Advantageously, therefore, the UE 3 is able to reliably determine that BSR is to be transmitted to the base station 5.

Transmitted data volume threshold

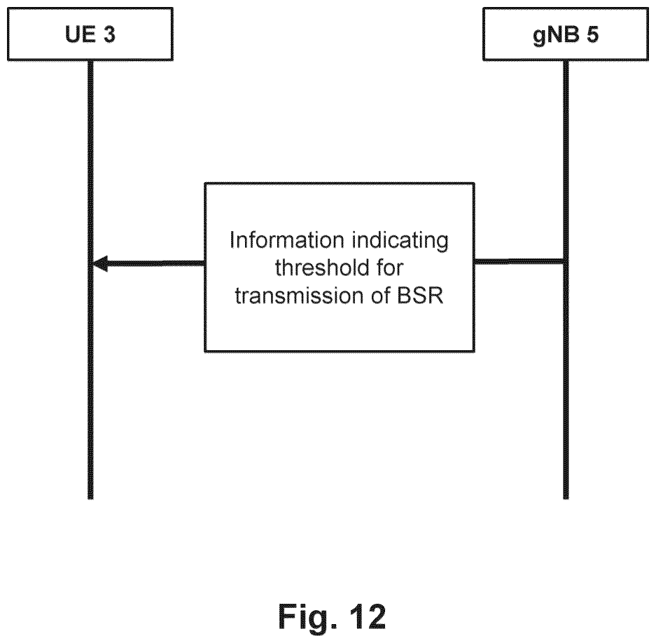

FIG. 12 shows an example in which the UE 3 receives a threshold for determining whether a BSR is to be transmitted. The UE 3 transmits a BSR to the base station 5 when a volume of data transmitted by the UE 3 exceeds a value corresponding to the threshold received from the base station 5.

The threshold is obtained at the base station 5 and transmitted to the UE 3. The threshold may be received at the base station 5 from any other suitable entity in the core network 7, or alternatively may be stored at the base station 5 (e.g. configured in a memory of the base station 5). In other words, the threshold may be configured by any suitable entity in the network 1.

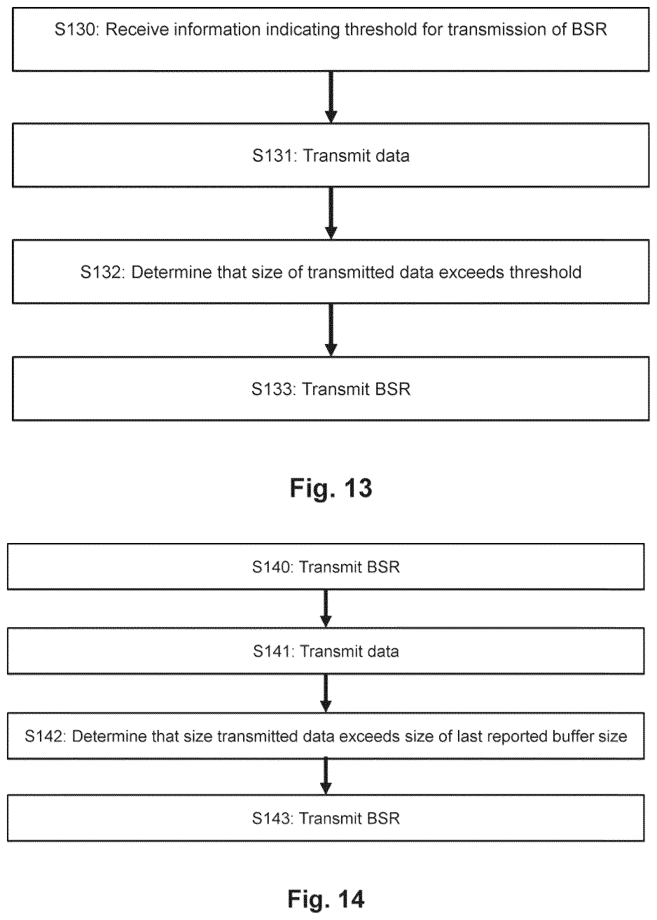

In this example, the threshold corresponds to a volume of transmitted data. FIG. 13 shows an example of how the threshold may be used by the UE 3 to determine that a BSR is to be transmitted.

In step S130, the UE 3 receives the information indicating the threshold for transmission of a BSR, from the base station 5.

In step S131, the UE 3 performs uplink transmission to transmit data to the base station 5.

In step S132, the UE 3 determines that the volume of data (which may also be referred to as a ‘size’ or ‘amount’ of data) transmitted to the base station 5 exceeds the volume indicated by the threshold received in step S130, and therefore determines that a BSR (e.g. a Regular BSR) is to be transmitted to the base station 5.

The UE 3 may additionally determine whether there is data present in the corresponding buffer, and only determine that the BSR is to be transmitted if there is data present in the corresponding buffer, in addition to the volume of data transmitted having exceeded the volume indicated by the threshold.

In order to determine the volume of data that has been transmitted, the UE 3 may count the data transmitted for each LCH or LCG separately, or alternatively may count the data for all LCH (or another suitable group or subset of LCH) collectively.

In step S133, the UE 3 transmits the BSR to the base station 5.

After the UE 3 has transmitted the BSR to the base station 5, the UE 3 resets the count of the volume of data transmitted by the UE 3, and the method returns to step S131.

Advantageously, therefore, the UE 3 is able to more reliably transmit BSR to the base station 5, by comparing the volume of transmitted data to the threshold received from the base station 5.

Data volume compared to previous reported buffer size

FIG. 14 shows a method in which the UE 3 determines to transmit a BSR based on a comparison between a volume of transmitted or scheduled UL data since a previous BSR was transmitted to the base station 5, and the buffer size reported in the previous BSR.

In step S140, the UE 3 transmits a BSR to the base station 5. The BSR includes an indication of a buffer size at the UE 3.

In step S141, the UE 3 transmits data to the base station 5.

In step 142, the UE 3 determines that the volume of data (for an LCH or LCG) transmitted to the base station 5 exceeds the buffer size reported in the BSR in step S140, and therefore determines that a BSR is to be transmitted to the base station 5. The UE 3 may optionally include data that is scheduled for transmission (e.g. data for transmission for a received UL grant) along with the data that has already been transmitted, when comparing to the buffer size reported in the previous BSR. In other words, the UE 3 may determine whether the sum of the data transmitted from the UE 3 to the base station 5 since the previous BSR was transmitted, and the volume of data currently scheduled for transmission to the base station 5, exceeds the buffer size reported in the previous BSR in step S140. In step S143, the UE 3 transmits the BSR to the base station 5.

Whilst in this example the UE 3 determines to transmit the BSR when the volume of data transmitted to the base station 5 from the UE 3 is greater than the buffer size reported in the previous BSR, the UE 3 may alternatively determine to transmit the BSR when the volume of data transmitted to the base station 5 is greater than or equal to the buffer size reported in the previous BSR, or may determine to transmit the BSR when the volume of data transmitted to the base station 5 is within a threshold range of the buffer size reported in the previous BSR.

The method illustrated in FIG. 14 may be referred to an ‘implicit transmitted data volume’ based method.

The UE may store a variable that corresponds to the unscheduled but reported buffer size for each LCG (e.g. ‘unscheduledbutReportedBufferSize’). This variable may be set (or reset) to the reported buffer size (e.g. the minimum possible size of the buffer size range corresponding to the index indicated in the BSR) when a BSR corresponding to the LCG has been transmitted to the base station 5 (e.g in step S140). The value of the variable stored at the UE 3 may then be reduced based on the amount of data for the LCG transmitted to the base station 5 (e.g. in step S141). When the value of the variable is less than a threshold value (e.g. 0), and if there is data in the corresponding buffer, the UE 3 determines that a BSR is to be transmitted to the base station 5.

Advantageously, therefore, the UE 3 is able to more reliably transmit BSR to the base station 5, based on the volume of data that has been transmitted to the base station 5 since a BSR was previously transmitted.

### Volume of Buffered Data

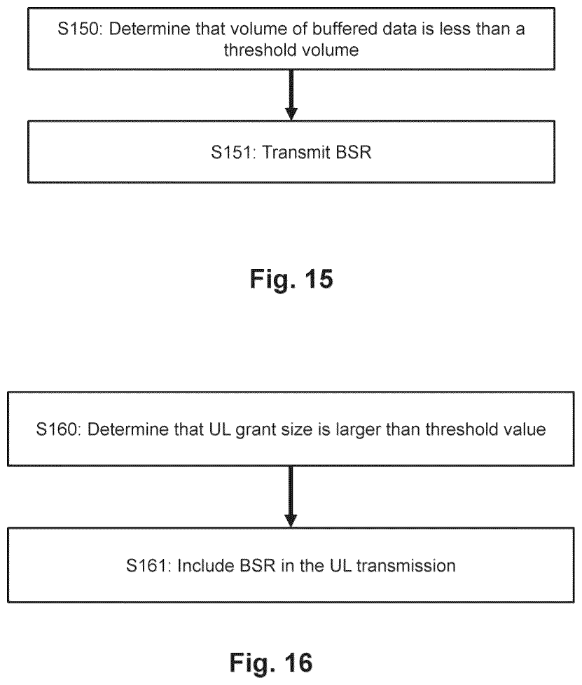

FIG. 15 shows a method in which the UE 3 determines that a BSR is to be transmitted to the base station 5, based on a volume of data buffered at the UE 3. In step S150, the UE 3 determines that a volume of data buffered at the UE 3 (e.g. for all LCG, or per LCG) is less (or alternatively ‘less than or equal to’) a configured threshold value, and therefore determines that a BSR is to be transmitted to the base station 5. The threshold value UE 3 may be preconfigured at the UE 3, or could alternatively be received from any other suitable entity of the network 1.

In step S141, the UE 3 transmits the BSR to the base station 5.

Advantageously, therefore, the UE 3 is able to more reliably transmit BSR to the base station 5, based on the volume of data buffered at the UE 3.

### UL Grant Size

FIG. 16 shows a method in which the UE 3 determines that a BSR is to be transmitted to the base station 5, based on an UL grant size.

In step S160, the UE 3 determines than an UL grant size (e.g. an UL grant size received from the base station 5) is larger than a threshold grant size. The threshold grant size may be preconfigured at the UE 3, or could alternatively be received from any other suitable entity of the network 1.

A large volume of data may require several uplink dynamic grants. Therefore, when the UL grant size is large, it is advantageous to have an updated and precise BSR available at the base station 5 for assigning at least one suitable UL grant size. Moreover, when the UL grant size is large, the overhead of including the BSR in a corresponding transmission to the base station 5 is relatively low.

Advantageously, therefore, the UE 3 is able to more reliably transmit BSR to the base station 5 based on the UL grant size, and the base station 5 can assign more suitable UL grant sizes and reduce overall resource usage (e.g. radio resource usage). Moreover, the BSR is advantageously transmitted when the relative overhead of the BSR is low.

Determination based on size of buffered data and buffer size reported in previous BSR

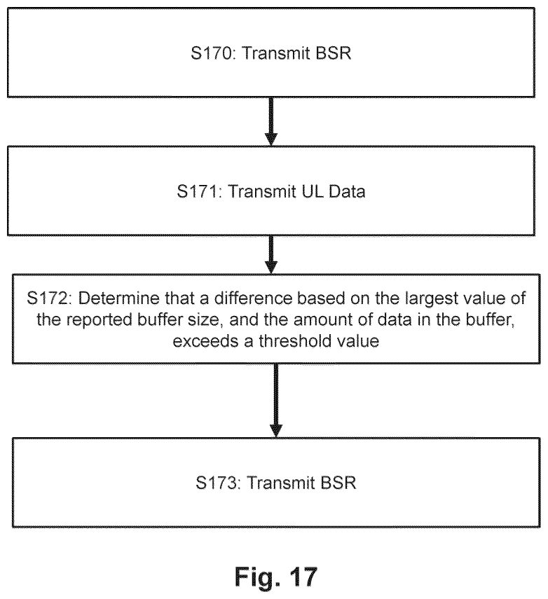

FIG. 17 shows a method in which the UE 3 determines whether to transmit a BSR based on the amount of data in the UE buffer, and based on a buffer size reported (or ‘indicated’) in a previous BSR.

In step S170, the UE 3 transmits a BSR to the base station 5.

In step S171, the UE 3 transmits data from the buffer to the base station 5 (e.g. after receiving an UL grant from the base station 5).

In step S172, the UE 3 determines that a difference based on the largest value of the buffer size reported in step S170 and the amount of data currently in the buffer is greater than a threshold value (or alternatively is greater than or equal to a threshold value), and therefore determines that a BSR is to be transmitted to the base station 5. The UE 3 takes into account the volume of data that has been transmitted to the base station 5 in step S171, when performing this determination. In other words, as shown in the example below, the UE determines whether the difference between the value of the current buffer size that could be calculated by the base station 5 and the actual buffer size exceeds a threshold value.

In step S173, the UE 3 transmits the BSR to the base station 5.

The ‘largest value of the buffer size reported’ is the upper value of the range indicated in the BSR. For example, referring to FIG. 6, when the reported index in the previous BSR was 11, the largest value of the reported buffer size is 276 (the upper value of the range of possible buffer size values corresponding to that index).

When B represents the amount of data currently in the UE 3 buffer, and E represents the largest possible buffer size based on the previously transmitted buffer size index (and based on the data transmitted from the UE 3 to the base station 5 since the BSR was transmitted), the UE 3 determines whether E-B (in case of E>=B), or B-E (in case of B>=E) is greater than a threshold value T. For example, referring to Table 1 above, when the buffer of the UE 3 is initially empty and the UE 3 then receives a packet of size 60000 bytes in the buffer, the size of the buffer is 60000 bytes, and the index included in the BSR in step S170 is therefore ‘139’ (because the buffer size is greater than 58784 and less than or equal to 62599). In this case, E-B=62599−60000=2599. Therefore, if the threshold T is 1000, then E-B>T. However, the UE does not yet transmit another BSR, because the BSR is triggered to be sent based on data arrival. If then UE is then scheduled to transmit, and transmits, 50000 bytes of data from the buffer in step S171, then B=10000, E=12599 (because E is calculated taking into account the volume of transmitted data: E=62599-50000), and E-B=2599. Since E-B is greater than the threshold value of 1000, and therefore there is a relatively large discrepancy between the buffer size that could be calculated or estimated by the base station 5 and the actual buffer size, the UE determines to transmit a new BSR to reduce the value of E-B, or if then there are more data e.g., 2000 bytes arriving in the buffer, then B=30000, E=12599, and B-E=17401. Since B-E is greater than the threshold value of 1000, and therefore there is a relatively large discrepancy between the buffer size that could be calculated or estimated by the base station 5 and the actual buffer size, the UE determines to transmit a new BSR to reduce the value of B-E.

In other words, the transmission of the BSR in step 173 is based on the difference between the actual volume of buffered data at the UE 3, and the volume of buffered data at the UE 3 that the base station 5 could determine or estimate (based on the previous BSR and the subsequent UL data transmissions received from the UE 3).

Advantageously, therefore, the UE 3 is able to provide a more accurate indication of the buffer size to the base station 5, enabling the base station 5 to schedule UL resources more efficiently.

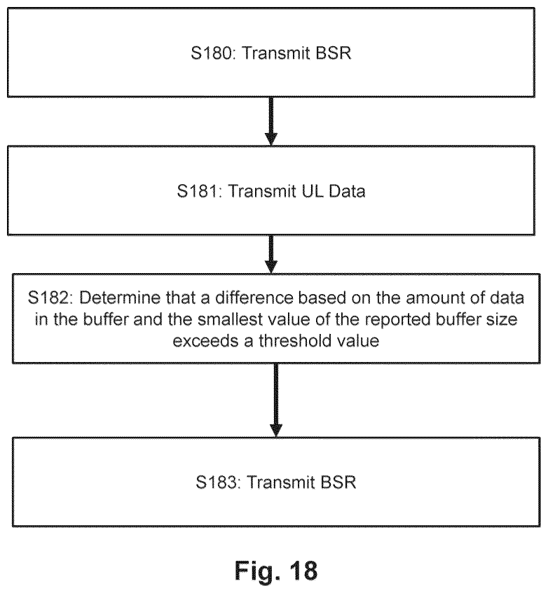

FIG. 18 shows a modification of the method of FIG. 17, in which the UE 3 instead determines that a difference based on the smallest value of the buffer size reported in step S170 and the amount of data currently in the buffer is greater than a threshold value (or alternatively is greater than or equal to a threshold value).

Steps S180, S181 and S183 are the same as steps S170, S171 and S173, respectively.

In this example, the UE 3 uses the smallest value of the buffer size reported in step S180. The ‘smallest value of the buffer size reported’ is the lower value of the range indicated in the BSR. For example, referring to FIG. 6, when the reported index in the previous BSR was 11, the largest value of the reported buffer size is 199 (the lowest value of the range of possible buffer size values corresponding to that index).

When B represents the amount of data currently in the UE 3 buffer, and E′ represents the smallest possible buffer size based on the BSR transmitted in S180 (and based on the data transmitted from the UE 3 to the base station 5 in S181), the UE 3 determines whether B-E′ is greater than a threshold value T. For example, referring to Table 1 above, when the buffer of the UE 3 is initially empty and the UE 3 then receives a packet of size 60000 bytes in the buffer, the size of the buffer is 60000 bytes, and the index included in the BSR in step S170 is therefore ‘139’ (because the buffer size is greater than 58784 and less than or equal to 62599). In this case, B-E′=60000−58784=1216. Therefore, if the threshold T is 1000, then B-E′>T. However, the UE does not yet transmit another BSR, because the BSR is triggered to be sent based on data arrival. If then UE is then scheduled to transmit, and transmits, 50000 bytes of data from the buffer in step S181, then B=10000, E′=8784 (because E′ is calculated taking into account the volume of transmitted data: E′=58784-50000), and B-E′=1216. Since B-E′ is greater than the threshold value of 1000, and therefore there is a relatively large discrepancy between the buffer size that could be calculated or estimated by the base station 5 and the actual buffer size, the UE determines to transmit a new BSR to reduce the value of B-E′.

### BSR Difference Information

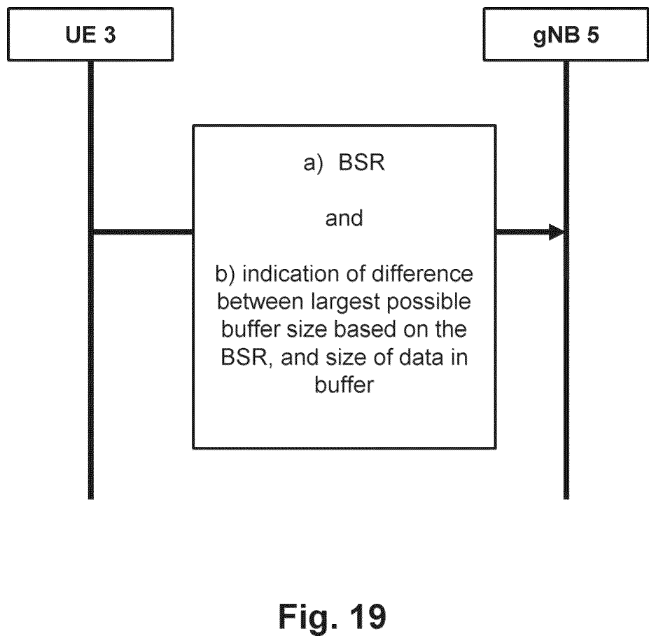

FIG. 19 shows an example in which the UE 3 transmits an indication of a difference between the largest possible buffer size based on the current regular/periodical BSR, and current size of data in buffer, in addition to transmitting the regular/periodical BSR.

As shown in the figure, the UE transmits a BSR to the base station 5, and also transmits an indication of a difference between the largest possible buffer size based on the BSR, and current size of data in buffer.

For example, where B represents the amount of data currently in the buffer, and E represents the largest possible buffer size based on the buffer size index in the BSR, the UE 3 may transmit the value of E-B (in this example, as a MAC CE) to the base station 5. The ‘largest possible buffer size’ is the upper value of the range indicated in the BSR. For example, referring to FIG. 6, when the reported index in the BSR is 11, the largest value of the reported buffer size is 276 (the upper value of the range of possible buffer size values corresponding to that index). The base station 5 may use the value of E-B in order to obtain a more accurate determination of the actual buffer size at the UE 3 (e.g., using the buffer size values provided in Table 1 above), and is therefore able to schedule UL resources more efficiently.

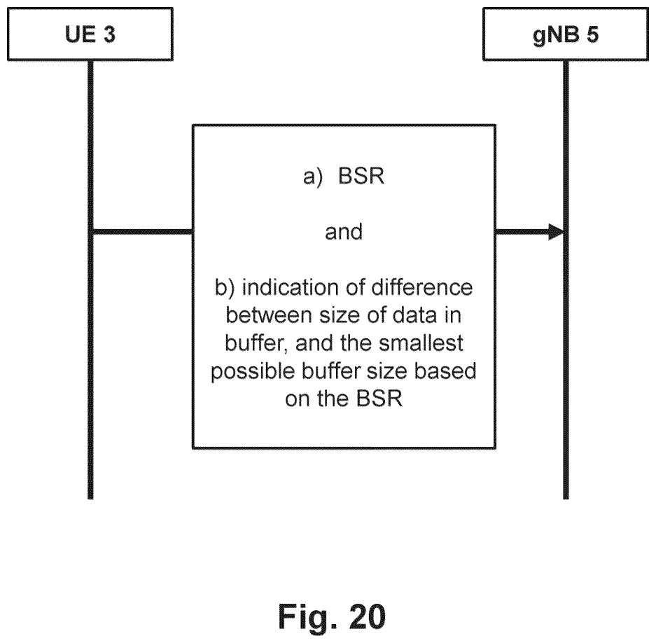

FIG. 20 shows a modification of FIG. 19 in which the UE 3 transmits an indication of a difference between the actual amount of data in the buffer and the smallest possible data volume based on the BSR index/Buffer size included in the BSR. For example, where B represents the amount of data currently in the buffer, and E′ represents the smallest possible buffer size based on the buffer size index in the BSR, the UE 3 may transmit the value of B-E (in this example, as a MAC CE) to the base station 5.

Whilst in the examples of FIGS. 19 and 20 the indications are transmitted as a MAC CE, another other suitable type of transmission from the UE 3 to the base station 5 could alternatively be used.

The value of E-B in the example of FIG. 19, and the value of B-E in the example of FIG. 20 (both of which may be referred to as the ‘buffer size difference’) may be transmitted (or triggered) when one or more of the following conditions are met:
The transmission of the buffer size difference is enabled by the network
Regular/periodical/truncated BSR report has been triggered and is going to be included in an available Uplink scheduled grant
The buffer size difference is larger than a threshold value (e.g. as determined by the UE 3)
A grant size of a regular/periodical/truncated BSR that has been triggered and is going to be included in an available Uplink scheduled grant is larger than a threshold value

### Buffer Size Tables

As described above with reference to FIG. 6, the range for the buffer size value becomes less precise for larger BSR indices (larger buffer size values). For example, when a 5-bit Buffer Size field is used for the BSR report, and the indicated index is 3, the buffer size value is larger than 14 bytes and smaller than or equal to 20 bytes, corresponding to a range of 6 bytes. In contrast, when the indicated index is 28, the buffer size value is larger than 55474 bytes and smaller than or equal to 77284 bytes, corresponding to a range of 21810 bytes. In other words, the granularity of the indicated buffer level becomes less fine as the size of the index becomes larger. However, it is desirable for the base station 5 to have a more precise range for the buffer size value, for example when the base station 5 is about to complete the scheduling of data based on the reported buffer size.

The present inventors have realised that it is advantageous to provide a table that maps the BSR indices to the corresponding buffer size values, based on a particular service or device type. For example, for video streaming in an XR implementation, the typical packet size may fall within a particular range. The present inventors have realised that the table can be configured to provide smaller ranges (i.e. finer granularity) of the buffer size values for the typical packet sizes, which increases the overall precision of the BSRs.

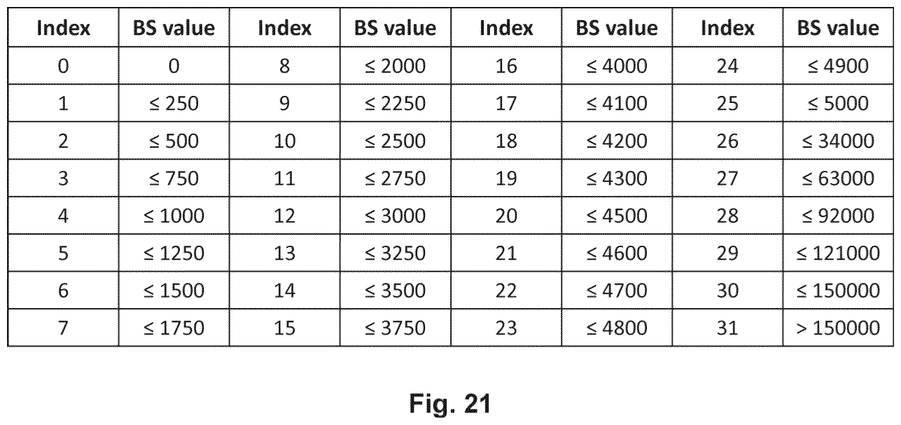

FIG. 21 shows a modified version of the table of FIG. 6, in which the mapping between the indices and the buffer size values has been modified to provide finer granularity for buffer size values between 4000 bytes and 5000 bytes (e.g. because a typical packet size for a particular application or service is between 4000 bytes and 5000 bytes). For example, when the actual buffer size at the UE 3 is 4150 bytes, if the table of FIG. 6 were used then an index value of 20 would be included in the BSR, which indicates that the buffer size value is larger than 3909 bytes and less than or equal to 5446 bytes (a range of 1537 bytes). In contrast, when using the table of FIG. 21, an index value of 18 would be included in the BSR, which indicates that the buffer size value is larger than 4100 bytes and smaller than or equal to 4200 bytes (a smaller range of 100 bytes). Therefore, the BSR provides a more precise indication to the base station 5 of the actual buffer size, and the base station is able to schedule UL resources more efficiently.

The UE 3 may store a plurality of mapping tables, such as the tables illustrated in FIGS. 6 and 21, and the network may provide an indication to the UE 3 of which table to use to generate a BSR. For example, the network may provide an indication that the UE 3 is to use a particular mapping table based on a type of the UE 3, or based on a service used or requested by the UE 3 (the UE 3 may use a particular table based on a network configuration). Alternatively, the UE 3 may select a table to use, and may provide an indication of the selected table to the base station 5.

Alternatively (or additionally), a new BSR MAC CE in which more than 8 bits are used to indicate the buffer size value could be used, enabling a larger number of indices to be used to map to the buffer size values, and therefore mapping each index to a smaller range of buffer sizes.

### Grant Assistance Information

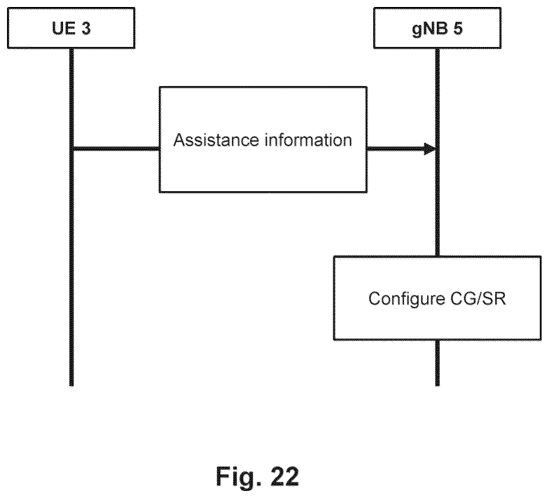

FIG. 22 shows an example in which the UE 3 transmits configured grant (CG)/scheduling request (SR) assistance information to the base station, which advantageously helps to address a problem that a mismatch between the data arrival timing at the UE 3 and the CG position can occur. This can occur, for example, due to jitter (which can be difficult to predict), or non-integer periodicity. The present inventors have realised that this problem can be at least partially ameliorated by providing a UE-assisted CG configuration (and in particular the timing of the CG).

The base station 5 may optimise power consumption for one or more UEs by configuring a so-called Discontinuous Reception (DRX) and/or Discontinuous Transmission (DTX) operation. Both DRX and DTX are based on reducing the UE's 3 transceiver duty cycle while in active operation. In DRX mode, the base station 5 sets a cycle during which the UE 3 is operational for a certain period of time (referred to as ‘active time’ or ‘on duration’) and the base station 5 transmits all scheduling and paging information (for this UE) during this period only. The UE 3 can thus turn off its transceiver for the rest of the DRX cycle (which may also be referred to as ‘inactive time’ or ‘off duration’). In DTX mode, the UE 3 does not turn off its transceiver completely, but keeps monitoring the Physical Downlink Control Channel (PDCCH) to be able to receive data from the base station 5 without undue delay. The longer the ‘off’ duration relative to the duty cycle, the more power saving can be achieved. However, when operating in DRX and/or DTX mode, the UE's 3 data throughput is reduced in proportion to the achieved power savings since the UE 3 can transmit/receive data during the active time only. Jitter may cause misalignment between data arrival and the on period of the DRX cycle. The effect of jitter is that the exact frame arrival timing would be a bit earlier or later than expected due to a random delay, which is caused by the operation of frame encoders in edge servers, network transfer time in the core network, etc.

A further issue may be referred to as ‘non-integer periodicity’ of XR data packets (i.e. non-integer number of subframes). Specifically, in case of XR, the packet arrival rate is determined by the frame generation rate (e.g. 60 fps). Accordingly, the average packet arrival periodicity is given by the inverse of the frame rate (e.g. 1/60 fps=16.6667 ms), without considering jitter (i.e. assuming fixed video encoding time, fixed network transfer delay). Thus, the arrival time at the base station for a packet with index k (k=1, 2, 3, . . . ) is given as k/F*1000 [ms] where F is the given frame generation rate (per second). The difference between the non-integer arrival rate (in this example 16.6667 ms) and the nearest periodicity given in units of subframes (e.g. 17 ms) causes the buffer time of subsequent packets to get longer and longer (accumulated). In other words, an additional 0.3333 ms delay may be added (and accumulated) at each new data packet corresponding to a new frame.

As illustrated in FIG. 22, in this example the UE 3 transmits assistance information for CG and/or SR to the base station 5. The assistance information may comprise information related to traffic characteristics (and the assistance information may simply be referred to as ‘traffic information’). The base station 5 then configures CG/SR based on the received assistance information.

The information related to traffic characteristics may comprise:
Periodical traffic timing information represented by:
   Periodicity/packet generate rate and offset of the traffic (e.g. an offset of a packet arrival timing from the start of the corresponding period)
Possible jitter range
Desired/Requested configurations, e.g:
   uplink CG request including periodicity, offset and optionally TB size (to match to the periodical packets arrival timing)
   SR configuration including periodicity, offset (to match to the periodical packets arrival timing)

The UE may transmit the assistance information when requested by the network. Alternatively, for example, the UE 3 may transmit the assistance information periodically.

Advantageously, therefore, the base station 5 can use the assistance information to provide an improved configuration of CG/SR.

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

It will be appreciated that the above embodiments may be applied to both 5G New Radio and LTE systems (E-UTRAN). The above embodiments may also be applied to future systems (beyond 5G, 6G, etc.).

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower-level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU. gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C(F1 control plane) interface connected with the gNB-DU. gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station.

The above embodiments are also applicable to ‘non-mobile’ or generally stationary user equipment. The above-described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IOT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless

Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

This application is based upon and claims the benefit of priority from United Kingdom Patent Application No. 2209591.3, filed on Jun. 29, 2022, the disclosure of which is incorporated herein in its entirety by reference.

For example, the whole or part of the exemplary example embodiments disclosed above can be described as, but not limited to, the following supplementary notes.

(Supplementary note 1)

A user equipment (UE) comprising:
means for determining whether to transmit a buffer status report (BSR) to a base station based on at least one of:
a volume of data stored at the UE;
a volume of data transmitted by the UE;
a threshold value; or a BSR indication that indicates whether the BSR is to be transmitted from the UE to the base station; and
means for transmitting a BSR to the base station, based on the determining.
   (Supplementary note 2)

The UE according to Supplementary note 1, further comprising:
means for receiving, from a base station, the BSR indication, wherein
the means for transmitting the BSR is configured to transmit the BSR to the base station in a case where the BSR indication indicates that the BSR is to be transmitted to the base station.
   (Supplementary note 3)

The UE according to Supplementary note 2, wherein the BSR indication is included in a physical downlink control channel (PDCCH).

(Supplementary note 4)

The UE according to Supplementary note 3, wherein the BSR indication is provided as a 1-bit field in the PDCCH.

(Supplementary note 5)

The UE according to Supplementary note 2, wherein the BSR indication comprises a media access control (MAC) Control Element (CE).

(Supplementary note 6)

The UE according to Supplementary note 5, wherein the BSR indication is defined per logical channel group.

(Supplementary note 7)

The UE according to any one of Supplementary notes 1 to 6, wherein the BSR is a Regular BSR.

(Supplementary note 8)

The UE according to any one of Supplementary notes 1 to 7, wherein in a case where the BSR indication indicates that the BSR is to be transmitted to the base station, the means for transmitting is configured to transmit a BSR for one or more logical channel groups indicated in the BSR indication.

(Supplementary note 9)

The UE according to Supplementary note 1, wherein the means for determining is configured to determine to transmit the BSR to the base station when the volume of data transmitted by the UE exceeds the threshold value and there is data in a corresponding buffer at the UE.

(Supplementary note 10)

The UE according to Supplementary note 9, further comprising:
means for storing the value of the volume of data transmitted by the UE; and
means for setting the value of the volume of data transmitted by the UE to zero when the UE transmits the BSR.
   (Supplementary note 11)

The UE according to Supplementary note 1, wherein the threshold value corresponds to a buffer size reported in a first BSR transmitted to the base station from the UE; and
wherein the means for determining is configured to determine to transmit a second BSR to the base station when the sum of data transmitted by the UE to the base station and data scheduled for transmission from the UE to the base station exceeds the threshold value and there is data in a corresponding buffer at the UE.
   (Supplementary note 12)

The UE according to Supplementary note 1, wherein the means for determining is configured to determine to transmit the BSR to the base station when a volume of data stored in a buffer at the UE is less than the threshold value.

(Supplementary note 13)

The UE according to Supplementary note 1, wherein the threshold value corresponds to an UL grant size for the UE; and wherein the means for determining is configured to determine to transmit the BSR when the UL grant size is larger than the threshold value.

(Supplementary note 14)

The UE according to Supplementary note 1, wherein the means for determining is configured to determine to transmit the BSR to the base station when a highest value of a buffer size reported in a previous BSR, minus a current buffer size of a corresponding buffer at the UE, minus the data volume transmitted from the UE to the base station after the transmission of the previous BSR, is larger than the threshold value.

(Supplementary note 15)

The UE according to Supplementary note 1, wherein the means for determining is configured to determine to transmit the BSR to the base station when a current buffer size at the UE minus a smallest value of a corresponding buffer size reported in a previous BSR, minus the data volume transmitted from the UE to the base station after the transmission of the previous BSR, is larger than the threshold value.

(Supplementary note 16)

A user equipment (UE) comprising:
means for transmitting, to a base station, an indication of a difference between a buffer size corresponding to a buffer status report (BSR) and a volume of data stored in a corresponding buffer at the UE.
   (Supplementary note 17)

The UE according to Supplementary note 16, wherein the buffer size corresponding to BSR is an upper limit of a range of buffer sizes indicated in the BSR.

(Supplementary note 18)

The UE according to Supplementary note 17 wherein the indication includes a value equal to the upper limit of the range of buffer sizes indicated in the BSR minus the volume of data stored in a buffer at the UE.

(Supplementary note 19)

The UE according to Supplementary note 16, wherein the buffer size corresponding to a BSR is a lower limit of a range of buffer sizes indicated in the BSR.

(Supplementary note 20)

The UE according to Supplementary note 19, wherein the indication includes a value equal to the volume of data stored in a buffer at the UE minus the lower limit of the range of buffer sizes indicated in the BSR.

(Supplementary note 21)

The UE according to Supplementary note 16, wherein the UE is configured to transmit the indication to the base station when at least one of:
the transmission of the indication is enabled by the network;
a Regular BSR, Periodical BSR or Truncated BSR reported has been triggered for transmission to the base station;
a value equal to the upper limit of the range of buffer sizes indicated in the BSR minus the volume of data stored in a buffer at the UE is greater than a threshold value;
a value equal to the volume of data stored in a buffer at the UE minus the lower limit of the range of buffer sizes indicated in the BSR is larger than a corresponding threshold value; or
a grant size for the UE for a Regular BSR, Periodical BSR or Truncated BSR is larger than a corresponding threshold value.
   (Supplementary note 22)

A user equipment (UE) comprising:
means for storing a plurality of tables, each table mapping each of a plurality of indices to respective range of a buffer size of the UE;
means for receiving an indication of a table of the plurality of tables to use to determine an index that corresponds to a size of a buffer at the UE; and
means for transmitting the index to a base station.
   (Supplementary note 23)

A user equipment (UE) comprising:
means for transmitting a buffer status report (BSR) media access control (MAC) control element (CE) to a base station;
wherein the BSR MAC CE comprises greater than 8 bits for indicating a corresponding buffer size.
   (Supplementary note 24)

A method performed by a user equipment (UE), the method comprising: determining whether to transmit a buffer status report (BSR) to a base station based on at least one of:
a volume of data stored at the UE;
a volume of data transmitted by the UE;
a threshold value; or
a BSR indication that indicates whether the BSR is to be transmitted from the UE to the base station; and transmitting a BSR to the base station, based on the determining.
   (Supplementary note 25)

A method performed by a user equipment (UE), the method comprising:
transmitting, to a base station, an indication of a difference between a buffer size corresponding to a buffer status report (BSR) and a volume of data stored in a corresponding buffer at the UE.
   (Supplementary note 26)

A method performed by a user equipment (UE), the method comprising:
storing a plurality of tables, each table mapping each of a plurality of indices to respective range of a buffer size of the UE;
receiving an indication of a table of the plurality of tables to use to determine an index that corresponds to a size of a buffer at the UE; and
transmitting the index to a base station.
   (Supplementary note 27)

A method performed by a user equipment (UE), the method comprising: transmitting a buffer status report (BSR) media access control (MAC) control element (CE) to a base station;
wherein the BSR MAC CE comprises greater than 8 bits for indicating a corresponding buffer size.
   (Supplementary note 28)

A system comprising a user equipment (UE) and a base station, wherein: the UE is configured to transmit, to the base station, uplink data transmission information including at least one of a periodicity or packet generation rate, a time offset, a jitter range, or a requested configuration related to uplink data transmissions from the UE to the base station; and
wherein the base station is configured to configure or schedule at least one uplink resource for uplink transmission based on the uplink data transmission information received from the UE.
   (Supplementary note 29)

A method performed in a system comprising a user equipment (UE) and a base station, the method comprising:
transmitting, by the UE, to the base station, uplink data transmission information including at least one of a periodicity or packet generation rate, a time offset, a jitter range, or a requested configuration related to uplink data transmissions from the UE to the base station; and
configuring or scheduling, by the base station, at least one uplink resource for uplink transmission based on the uplink data transmission information received from the UE.
   (Supplementary note 30) A base station comprising:
means for transmitting, to a user equipment (UE), at least one of:
a threshold value for determining whether to transmit a buffer status report (BSR) from the UE to the base station; or
a BSR indication that indicates whether a BSR is to be transmitted from the UE to the base station.
   (Supplementary note 31)

A base station comprising:
means for receiving, from a user equipment (UE), an indication of a difference between a buffer size corresponding to a buffer status report (BSR) and a volume of data stored in a corresponding buffer at the UE; and
means for determining, using the received indication, a current buffer size at the UE.
   (Supplementary note 32)

A base station comprising:
means for transmitting, to a user equipment (UE) that stores a plurality of tables, each table mapping each of a plurality of indices to respective range of a buffer size of the UE, an indication of a table of the plurality of tables to use to determine an index that corresponds to a size of a buffer at the UE; and
means for receiving the index from the UE.
   (Supplementary note 33)

A base station comprising:
means for receiving, from a user equipment, a buffer status report (BSR) media access control (MAC) control element (CE) comprising greater than 8 bits for indicating a corresponding buffer size; and
means for determining a buffer size at the UE using the BSR MAC CE.
   (Supplementary note 34)

A base station comprising:
means for receiving uplink data transmission information including at least one of a periodicity or packet generation rate, a time offset, a jitter range, or a requested configuration related to uplink data transmissions from a UE to the base station; and
means for configuring or scheduling at least one uplink resource for uplink transmission based on the uplink data transmission information received from the UE.
   (Supplementary note 35)

A method performed by a base station, the method comprising:
transmitting, to a user equipment (UE), at least one of:
a threshold value for determining whether to transmit a buffer status report (BSR) from the UE to the base station; or
a BSR indication that indicates whether a BSR is to be transmitted from the UE to the base station.
   (Supplementary note 36)

A method performed by a base station, the method comprising:
receiving, from a user equipment (UE), an indication of a difference between a buffer size corresponding to a buffer status report (BSR) and a volume of data stored in a corresponding buffer at the UE; and
determining, using the received indication, a current buffer size at the UE.
   (Supplementary note 37)

A method performed by a base station, the method comprising:
transmitting, to a user equipment (UE) that stores a plurality of tables, each table mapping each of a plurality of indices to respective range of a buffer size of the UE, an indication of a table of the plurality of tables to use to determine an index that corresponds to a size of a buffer at the UE; and
receiving the index from the UE.
   (Supplementary note 38)

A method performed by a base station, the method comprising:
receiving, from a user equipment, a buffer status report (BSR) media access control (MAC) control element (CE) comprising greater than 8 bits for indicating a corresponding buffer size; and
determining a buffer size at the UE using the BSR MAC CE.
   (Supplementary note 39)

A method performed by a base station, the method comprising:
receiving uplink data transmission information including at least one of a periodicity or packet generation rate, a time offset, a jitter range, or a requested configuration related to uplink data transmissions from a UE to the base station; and
configuring or scheduling at least one uplink resource for uplink transmission based on the uplink data transmission information received from the UE.

### REFERENCE SIGNS LIST

1 mobile (cellular or wireless) telecommunication system
3A, 3B mobile device (user equipment, UE)
5 base station
7 core network
10 control plane function (CPF)
11 user plane function (UPF)
20 data network
31 transceiver circuit
33 antenna
35 user interface
37 controller
39 memory
41 operating system
43 communications control module
45 buffer status report (BSR) module
51 transceiver circuit
53 antenna
55 network interface
57 controller
59 memory
61 operating system
63 communications control module
65 BSR module
67 UL scheduling module
71 transceiver circuit
75 network interface
77 controller
79 memory
81 operating system
83 communications control module

What is claimed is:

1-52. (canceled)

53. A method of a User Equipment (UE), the method comprising:
receiving first information from a network node;
determining, based on the first information, which of a first table or a second table to use to set a value of a buffer size field,
wherein, the first table indicates a mapping of buffer size values and indices, and a mapping of buffer size values and indices indicated by the second table is different from the mapping of buffer size values and indices indicated by the first table;
setting the value of the buffer size field using either the first table or the second table; and
transmitting, to the network node, a buffer status report (BSR) which is based on the value of the buffer size field.

54. A method of a network node, the method comprising:
transmitting first information to a User Equipment (UE); and
receiving a buffer status report (BSR) from the UE, wherein,
the first information is used to determine which of a first table or a second table is to be used to set a value of a buffer size field,
the first table indicates a mapping of buffer size values and indices, and a mapping of buffer size values and indices indicated by the second table is different from the mapping of buffer size values and indices indicated by the first table, and
the BSR is based on the value of the buffer size field.

55. A User Equipment (UE) comprising:
at least one memory configured to store instructions; and
at least one processor configured to execute the instructions to:
receive first information from a network node;
determine, based on the first information, which of a first table or a second table to use to set a value of a buffer size field,
wherein, the first table indicates a mapping of buffer size values and indices, and a mapping of buffer size values and indices indicated by the second table is different from the mapping of buffer size values and indices indicated by the first table;
setting the value of the buffer size field using either the first table or the second table; and
transmit, to the network node, a buffer status report (BSR) which is based on the value of the buffer size field.
